(19) United States
(12) Patent Application Publication
(10) Pub. No.: US 2026/0283129 A1
(43) Pub. Date: Sep. 24, 2026

(54) BIODEGRADABLE FLOAT

(71) Applicant: Top Catch LLC, Bon Air, VA (US)

(72) Inventor: Jack HERRMANN, Manakin Sabot, VA (US)

(21) Appl. No.: 19/572,077

(22) Filed: Mar. 19, 2026

Related U.S. Application Data
(60) Provisional application No. 63/776,190, filed on Mar. 23, 2025.

(51) Int. Cl. A01K 93/00

(52) U.S. Cl. CPC A01K 93/00

(57) ABSTRACT

A biodegradable fishing bobber or float including a body formed from an engineered biodegradable polymer composition, such as a polyhydroxyalkanoate (PHA) polymer or blend thereof, optionally containing 5-30% mineral filler, and optionally incorporating an internal multi-chamber ribbed structure that maintains buoyancy during use yet sinks upon shell breach to enable rapid marine biodegradation. The engineered geometry and composition provide casting performance and bite sensitivity equivalent to or better than conventional plastic bobbers while eliminating long-term plastic pollution in aquatic ecosystems.

### CROSS-REFERENCE TO RELATED APPLICATIONS

This application claims priority benefit to U.S. Provisional Patent Application Ser. No. 63/776,190 filed Mar. 23, 2025, which is incorporated herein by reference.

### TECHNICAL FIELD

The present disclosure relates to fishing equipment and materials, and more particularly to biodegradable fishing bobbers or floats, which are engineered to provide enhanced castability, buoyancy, and bite detection while minimizing environmental impact.

### BACKGROUND

Fishing is a widely practiced recreational and commercial activity, with anglers relying on various tools and accessories, including bobbers or floats, to detect bites, control bait placement, and improve overall catch success. Traditional fishing bobbers are commonly made from non-biodegradable plastics or synthetic polymers, which, when lost or discarded, for example after a snag or line break, persist in aquatic environments, contribute to water pollution, and pose risks to wildlife. Lost bobbers may be ingested by fish, potentially leading to gastrointestinal blockages, or may fragment into microplastics that accumulate in freshwater and marine ecosystems.

Existing float or bobber designs also often exhibit limitations that affect fishing performance. Traditional bobbers may suffer from suboptimal buoyancy profiles and weight distribution, reducing bite sensitivity and increasing the risk of bait loss during casting. Furthermore, certain shapes can create unnecessary resistance or drag in the water during retrieval, and/or in the air during casting, requiring increased effort and reducing overall efficiency.

Natural materials such as wood, balsa, or cork have been used in fishing bobbers, but these materials may exhibit variability in density and structure, resulting in inconsistent buoyancy and performance. Additionally, exposure to water can cause swelling or absorption, increasing weight and reducing buoyancy over time, which negatively impacts functionality.

Attempts to produce environmentally friendly or biodegradable bobbers have been made, but these designs often fail to fully degrade in aquatic or soil environments, lack sufficient mechanical properties to withstand typical fishing stresses, or require costly and impractical manufacturing. Consequently, there remains a need for a fishing bobber or float that provides consistent and reliable performance while reducing environmental impact. Specifically, it has now been discovered that there is a need for a bobber formed from engineered biodegradable materials that maintain structural integrity during use, provide controlled buoyancy, support casting performance, and degrade after exposure to environmental conditions.

It is to the provision of improved fishing floats or bobbers meeting these and other needs that the present invention is primarily directed.

### SUMMARY

In example embodiments, the present disclosure provides a biodegradable fishing bobber formed from materials including but not limited to engineered polymer compositions comprising one or more biodegradable polymers, including, but not limited to, polyhydroxyalkanoates (PHA), polylactic acid (PLA), polybutylene succinate (PBS), polycaprolactone (PCL), or blends thereof. The polymer composition may further include fillers, such as talc, calcium carbonate, or other inert, naturally occurring mineral additives, colorants for improved visibility, and/or additional materials, additives or coatings. The engineered composition is configured to balance mechanical performance, manufacturability, and biodegradability.

In some particular example embodiments, the polymer composition includes a combination of semi-crystalline and amorphous biodegradable polymers, wherein the semi-crystalline component provides stiffness and shape retention, and the amorphous component provides flexibility and impact resistance. The relative ratios of the semi-crystalline to amorphous polymers may be adjusted, for example, between 40:60 and 60:40 by weight, to optimize the mechanical properties and manufacturability of the bobber. The total polymer content may range from approximately 70% to 90% by weight of the composition.

One or more fillers such as talc or calcium carbonate may be incorporated in amounts ranging from 5% to 30% by weight. The inclusion of these fillers improves stiffness, hardness, thermal stability, and dimensional stability during molding while maintaining overall biodegradability. Optional additives, including pigments, stabilizers, or nucleating agents, may also be included in small amounts to adjust color, performance, and degradation rate.

The bobber is configured with one or more, and preferably a plurality of, hollow internal chambers and internal rib structures dividing the chambers. The chambers reduce the effective density of the bobber below that of water, thereby enabling floatation, while the ribs transfer and absorb impact forces during casting or retrieval. Wall thickness may vary depending on desired durability, ranging from approximately 0.2 mm to 1.2 mm or greater. The number, size, and geometry of the chambers, together with wall thickness, allow selective tuning in design and manufacture of both buoyancy and controlled degradation after use.

The combination of biodegradable polymer composition, filler content, and internal geometry is non-obvious and novel. While high filler content in conventional polymers typically increases density, preventing or reducing floatation characteristics, the internal hollow chamber design of the present disclosure compensates for this increase, allowing the bobber to float while retaining mechanical strength. The semi-crystalline/amorphous polymer blend prevents brittle failure on impact, which neither polymer type alone could achieve, and the ribbed, multi-chamber structure allows thin walls to be used without compromising structural integrity.

The engineered combination of polymer blend, filler composition, and internal chamber design provides a tunable balance of mechanical robustness, floatation, casting performance, and controlled biodegradation. The design also enables casting distances and weights that would otherwise require environmentally harmful dense materials such as lead, providing an ecologically safer alternative without compromising performance.

In various embodiments, a bobber or float according to the present disclosure may be manufactured using additive manufacturing techniques such as fused filament fabrication (FFF) or fused deposition modeling (FDM) for prototyping and complex internal geometries, and using injection molding, compression molding, or extrusion for high-volume production with controlled wall thickness, filler distribution, and internal chamber design.

In one aspect, the present invention relates to a biodegradable float for fishing. The float preferably includes an outer shell and at least one hollow interior chamber within the outer shell. The float is preferably formed at least in part, or substantially completely, of a biodegradable polymer composition selected from polyhydroxyalkanoate, polylactic acid, polybutylene succinate, polycaprolactone, and combinations thereof.

In another aspect, the present invention relates to a biodegradable float for fishing. The float preferably includes a water-tight outer shell bounding a generally hollow interior, and having a maximum wall thickness of approximately 1.2 mm. The float preferably also includes at least one interior wall dividing the generally hollow interior of the outer shell into a plurality of interior chambers, whereby the float maintains buoyancy in water in the event of the outer shell being damaged and at least one of the plurality of interior chambers being compromised and filled with water. The outer shell and the at least one interior wall are preferably formed at least in part, or substantially entirely of, a biodegradable polymer composition comprising at least 70% of a polyhydroxyalkanoate material.

In still another aspect, the present invention relates to a method of manufacturing a biodegradable float for fishing. The method preferably includes forming a water-tight outer shell bounding a generally hollow interior, the outer shell being formed of a biodegradable polymer composition selected from polyhydroxyalkanoate, polylactic acid, polybutylene succinate, polycaprolactone, and combinations thereof. The forming step preferably includes one or more of additive manufacturing, 3D printing, injection molding, compression molding, extrusion, and/or combinations thereof.

These and other aspects, features and advantages of the invention will be understood with reference to the drawing figures and detailed description herein and will be realized by means of the various elements and combinations particularly pointed out in the appended claims. It is to be understood that both the foregoing general description and the following brief description of the drawings and detailed description of example embodiments are explanatory of example embodiments of the invention, and are not restrictive of the invention, as claimed.

### BRIEF DESCRIPTION OF THE DRAWINGS

FIGS. 1A-1E (collectively, FIG. 1) show example arrangements for use of a biodegradable float for fishing according to example embodiments of the disclosure.

FIG. 2 shows a biodegradable float according to an example embodiment of the disclosure.

FIGS. 3A-3C (collectively, FIG. 3) show side and cross-sectional views as indicated of biodegradable floats according to example embodiments of the disclosure.

FIGS. 4A-4E (collectively, FIG. 4) show side and cross-sectional views as indicated of biodegradable floats according to example embodiments of the disclosure.

FIGS. 5A-5D (collectively, FIG. 5) show a sequence of biodegradable breakdown of a biodegradable float according to an example embodiment of the disclosure.

### DETAILED DESCRIPTION OF EXAMPLE EMBODIMENTS

The present invention may be understood more readily by reference to the following detailed description of example embodiments taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

The present disclosure is generally directed to biodegradable fishing floats or bobbers, associated methods of manufacture and use, and methods for reducing plastic debris in aquatic ecosystems by utilizing a bobber or float comprising biodegradable polymer materials.

As used herein, the term “bobber” or “float” refers to a fishing float device configured to suspend bait, hooks, or lures at a predetermined depth below the water surface. A bobber may also serve as a visual strike indicator that moves or submerges when a fish interacts with the bait. Bobbers are commonly attached to a fishing line and positioned at adjustable locations along the line.

As used herein, the term “approximately” means within 10% of the stated value unless otherwise specified.

Conventional fishing bobbers are typically manufactured from petroleum-based plastics, foams, or hollow molded materials that are not biodegradable. When lost during fishing activities, these products may persist in aquatic environments for extended periods and contribute to environmental pollution and microplastic contamination. As fishing participation increases worldwide, the accumulation of non-biodegradable fishing equipment in aquatic environments has become a growing ecological concern. Discarded fishing floats may persist for many years, potentially being ingested by wildlife or fragmenting into microplastics.

In contrast to conventional products, the bobbers or floats described herein are formed from biodegradable polymer materials capable of breaking down in aquatic and/or soil environments into environmentally benign components. In some embodiments, the bobber body comprises a biodegradable polymer, which may include polyhydroxyalkanoate (PHA), polylactic acid (PLA), polybutylene succinate (PBS), polycaprolactone (PCL), polyhydroxybutyrate (PHB), or blends thereof. The biodegradable polymer composition may include one or more amorphous polymers, semi-crystalline polymers, or combinations thereof to achieve a balance of mechanical performance, manufacturability, and controlled degradation. When PHA is exposed to microbial activity in soil, compost, or water, it is typically broken down by enzymes called PHA depolymerases. Under aerobic conditions (with oxygen), in environments like surface soil or compost, PHA breaks down into carbon dioxide and water. Under anaerobic conditions (without oxygen), in marine environments, sediments, or in-ground, PHA breaks down into methane, carbon dioxide, and water. PHA generally feeds microbial biomass and does not leave behind microplastics residues.

In some example embodiments, the polymer composition includes PHA or PHA blends in a percentage by weight greater than about 50%, greater than about 60%, greater than about 70%, greater than about 80%, greater than about 90%, or approximately 100%. The specific ratio of amorphous to semi-crystalline polymer may be selected to provide sufficient flexibility to resist brittle failure while maintaining shape retention and manufacturability.

The polymer composition may optionally include additives such as mineral fillers, stabilizers, pigments, nucleating agents, plasticizers, or reinforcing agents to tune mechanical performance, density, or degradation profile. Example mineral fillers include talc, calcium carbonate, and similar naturally occurring or inert materials. These fillers may improve stiffness, hardness, dimensional stability, and thermal processing characteristics of the polymer composition. In certain embodiments, the concentration of fillers may range between approximately 0% and 40% by weight, between approximately 5% and 30% by weight, or between approximately 10% and 25% by weight, depending on the desired combination of mechanical performance, density, and biodegradation rate.

The density of the polymer composition may be selected to achieve a desired buoyancy performance. In some embodiments, the bobber may have a bulk density between approximately 0.16 g/cm³ and 0.99 g/cm³, which may be further tuned by varying wall thickness, internal chamber volume fraction, and filler content.

The biodegradable polymer composition may be configured to provide a controlled and tunable rate of degradation in environmental conditions such as freshwater, marine water, or soil. The degradation rate may be influenced by polymer type, copolymer composition, degree of crystallinity, molecular weight, additive type and concentration, and exposure to environmental factors such as moisture, microbial activity, temperature, salinity, and ultraviolet radiation. In one embodiment, the biodegradable polymer composition comprises a polyhydroxyalkanoate (PHA) composition that meets TOV Austria's OK biodegradable MARINE standards. The finished bobber, while buoyant during normal use, is engineered such that upon compromise of the outer shell the body sinks, enabling accelerated biodegradation in the marine environment consistent with the certified performance of the PHA composition.

In some example embodiments, the bobber is designed to remain stable and maintain structural integrity during storage and normal fishing use. The polymer blend, filler content, and structural geometry are selected to resist degradation in dry or indoor environments, while enabling accelerated breakdown when exposed to aquatic or soil environments, thereby achieving controlled, environmentally triggered biodegradation.

The geometry and structure of the bobber body may further influence degradation rate. Parameters including wall thickness, surface area, internal chamber number, chamber volume, and chamber connectivity may be adjusted to control exposure to environmental conditions. Increased surface area or thinner walls may accelerate biodegradation, whereas thicker walls or reduced surface area may prolong structural integrity during use. In certain embodiments, the bobber body comprises an internal multi-chamber structure. The internal chambers may improve structural strength, distribute stress, and maintain buoyancy even if a portion of the outer shell is punctured or damaged. The bobber may include a plurality of internal chambers, for example, two or more internal chambers, three or more chambers, four or more chambers, or greater than five chambers. Complex internal geometries such as lattice structures, wipers, ribs, or multiple sealed chambers may be formed using additive manufacturing, 3D printing, injection molding, or other shaping techniques.

In some example embodiments, the internal structure comprises a cubic lattice infill pattern at approximately 5% infill density, wherein the lattice geometry distributes compressive and impact forces through a three-dimensional network of interconnected struts, enabling wall thicknesses of less than 1.5 mm, and in some example embodiments about 1.2 mm, and in further embodiments as thin as 0.4 mm, while maintaining structural integrity during repeated casting stresses. In further example embodiments, the maximum wall thickness is 6 mm or less, 4 mm or less, and in some examples 2.4 mm or less. In some embodiments, the internal chamber geometry and placement are designed to absorb impact forces from casting or handling and transfer stress to internal ribs or lattice structures, thereby preventing brittle failure of the outer shell and enabling thinner wall sections for buoyancy control. The number and placement of the internal ribs and lattice structures may be selectively configured in design and manufacture in conjunction with the external wall thickness and/or manufacturing processes in order to optimize material costs, manufacturing efficiency, buoyancy, durability, and/or other product characteristics.

The bobber body may include one or more weighted portions to optimize casting performance and orientation in water. The distribution of mass, chamber geometry, and overall dimensions may be selected to achieve aerodynamic stability during casting and hydrodynamic stability during retrieval. The shape of the bobber body may also be configured to reduce aerodynamic drag during casting. In some embodiments, the body comprises an elongated, ogive-like, or otherwise streamlined shape to improve cast distance while minimizing resistance during water retrieval. In other example embodiments, the body may be generally spherical, airfoil or wing-shaped, teardrop-shaped, or otherwise configured. The body may include one or more clips, loops, holes, channels, tie-offs, or other attachment features for fixed or movable attachment to a fishing line, leader, hook, or other fishing equipment or accessories.

The buoyancy characteristics of the bobber may be tuned by selecting appropriate polymer composition, filler content, internal chamber geometry, wall thickness, and total mass. These parameters allow the bobber to remain partially submerged under typical bait loads while remaining sensitive to fish strikes.

The biodegradable bobber may be manufactured using additive manufacturing (FFF/FDM), injection molding, compression molding, extrusion, or combinations thereof. Secondary operations may be applied to create precise chamber geometries, surface finishes, or integrated features.

The resulting bobber achieves a combination of mechanical performance, functional buoyancy, and environmentally triggered degradation that is not suggested in prior art. The integration of polymer composition, filler selection, and internal structure allows the bobber to maintain shelf stability and user performance while enabling controlled biodegradation when exposed to environmental conditions, reducing the long-term accumulation of plastic waste in aquatic ecosystems.

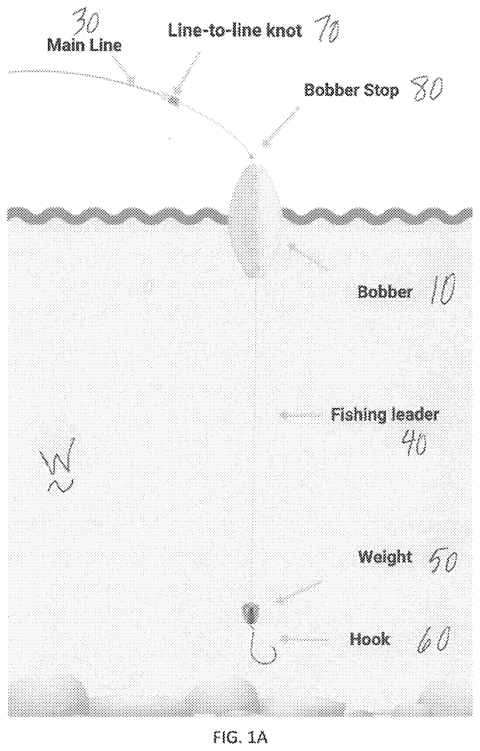

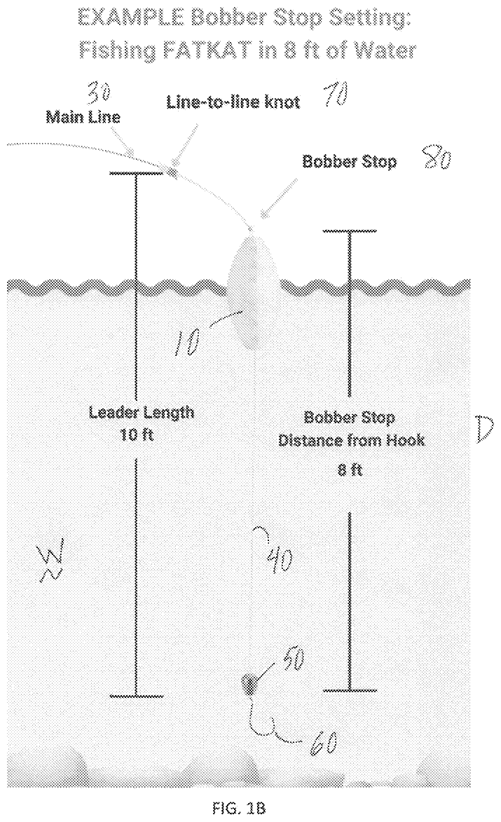

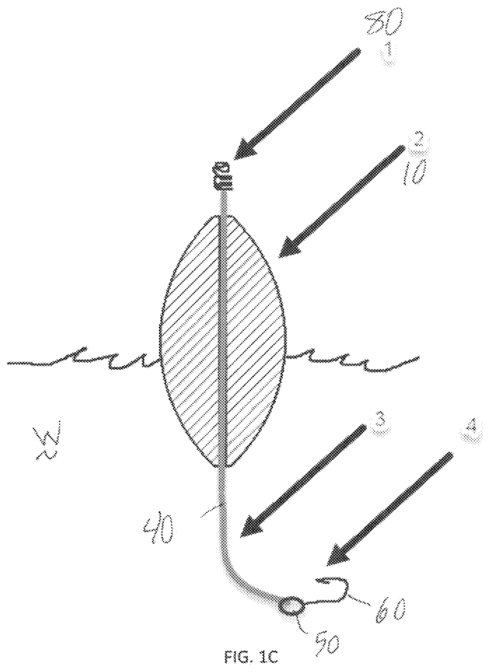

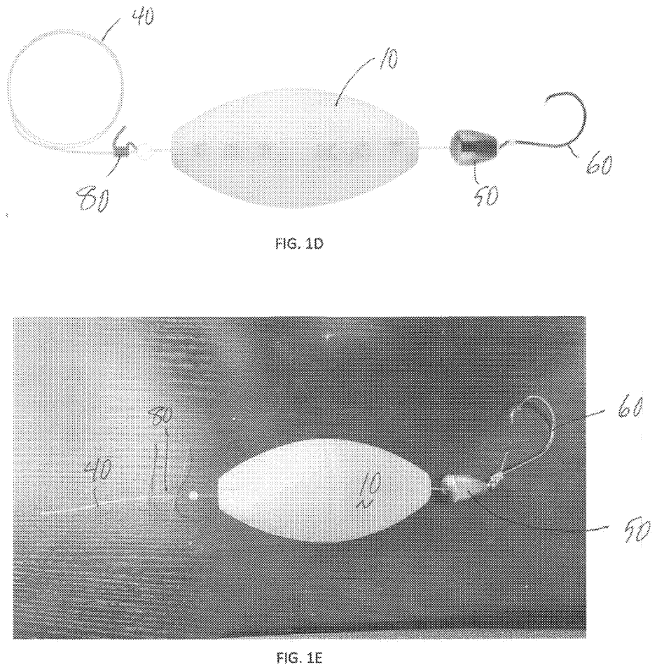

With reference now to the drawing figures, wherein like reference numbers represent corresponding parts throughout the several views, FIGS. 1A-1E (collectively, FIG. 1) show example systems and arrangements for use of a biodegradable float or bobber 10 for fishing according to example embodiments of the disclosure. In example embodiments, the float 10 is attached on the main fishing line 30 or a leader 40, for example in combination with a sinker or weight 50 and a fishing hook 60. Optionally, a line-to-line knot 70 may attach the main line 30 to the leader 40, and a bobber stop 80 may be used to adjust and maintain the position of the float 10 on the line to control the depth D at which bait placed on the hook 60 is positioned in a body of water W when fishing.

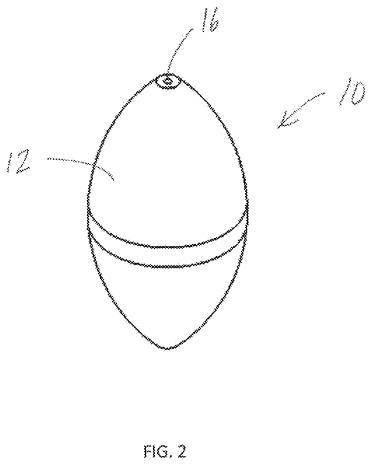

In example embodiments, and with reference to FIGS. 2-4, the float or bobber 10 may comprise a generally hollow three-dimensional body having an substantially continuous thin-walled, water-tight outer shell 12 with a spherical, rounded, oblong, ogive, ovoid outer shape. In depicted example embodiments, the outer shell 12 has a generally ogive taper at each end, with a maximum diameter D near its center and smaller first and second diametrical dimensions at each end, with a substantially continuous smoothly curved surface from end to end, and having an axial length L substantially longer than its central maximum diameter. In some examples, the length L is at least 1.25 to 1.5 times the maximum diameter D, and in particular examples the length L is 2 to 6 times the maximum diameter D. In some example embodiments, the ends of the outer shell comprise generally circular flat transverse end panels having generally equal or different diameters, for example with one end having a larger diameter transverse end panel and the opposite end having a smaller diameter transverse end panel. In some example embodiments, the exterior of the outer shell 12 includes a colorant, coating, painted surface, or one or more otherwise applied visual enhancement elements, such as a fluorescent, reflective, or brightly colored surface or pattern, for improved visibility by the fisherman as a strike indicator or locator.

A tubular channel or line sleeve 14 extends lengthwise axially through the body of the float 10, with openings 16 at opposite axial ends, to receive and allow the fishing line 30 or leader 40 to pass therethrough with a free-running or loose interference fit. The line sleeve preferably forms a continuous water-tight sealed surface with the outer shell 12, to prevent water from entering into the body of the float. In alternate embodiments, one or more clips, loops, holes, channels, tie-offs, or other attachment features are provided for fixed or movable attachment to the fishing line 30 or leader 40 instead of the line sleeve 14 extending therethrough to receive the line or leader.

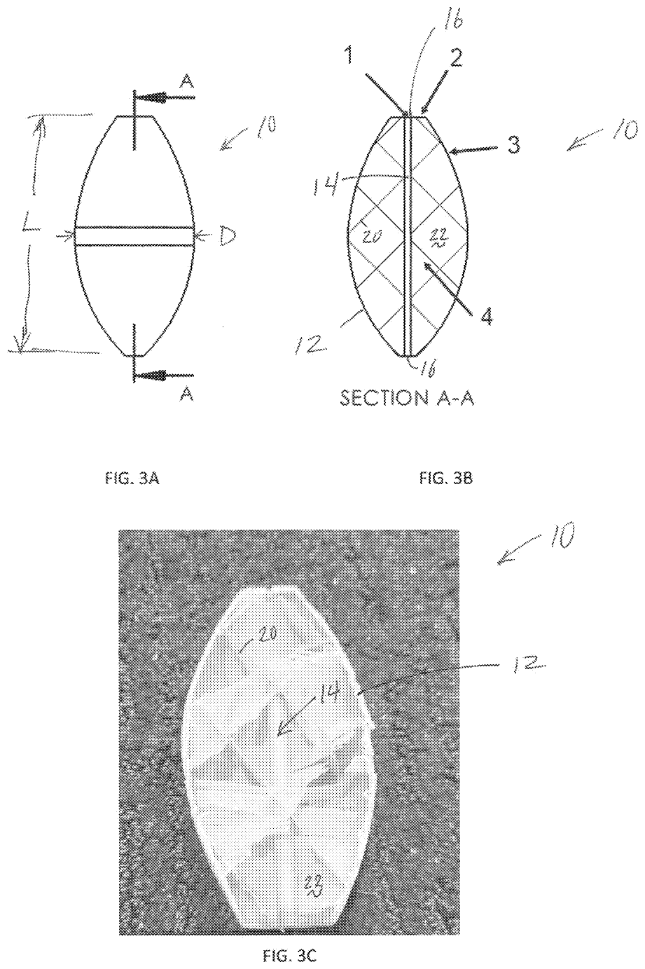

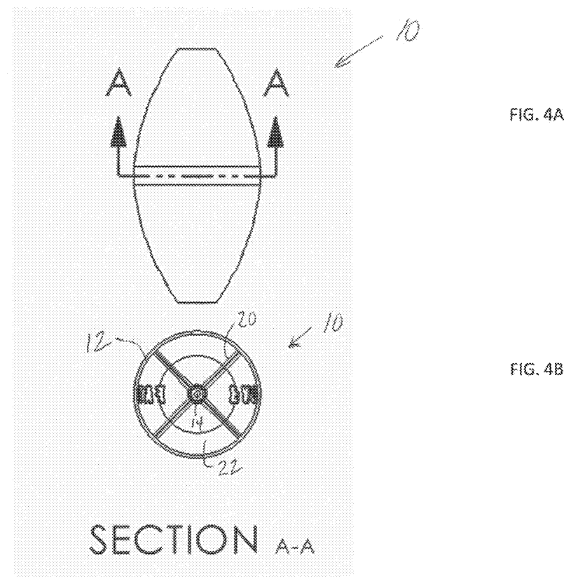

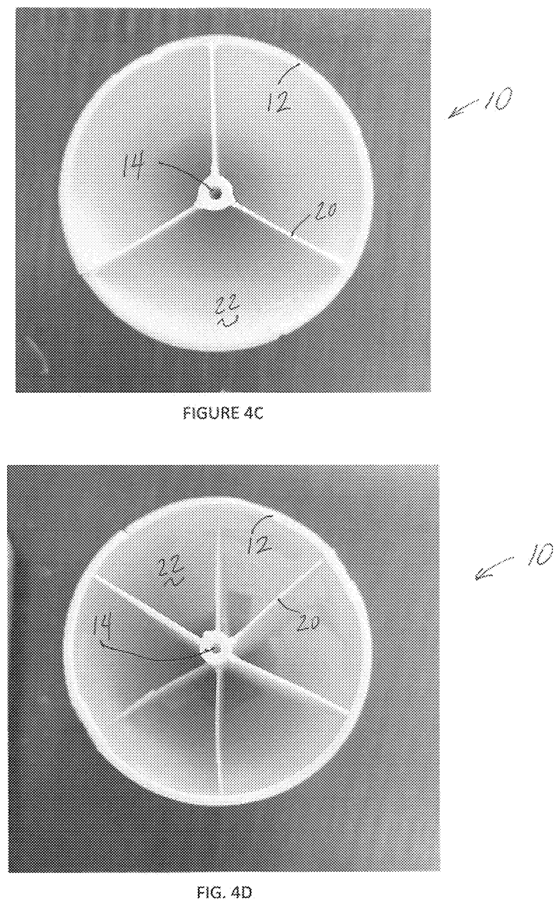

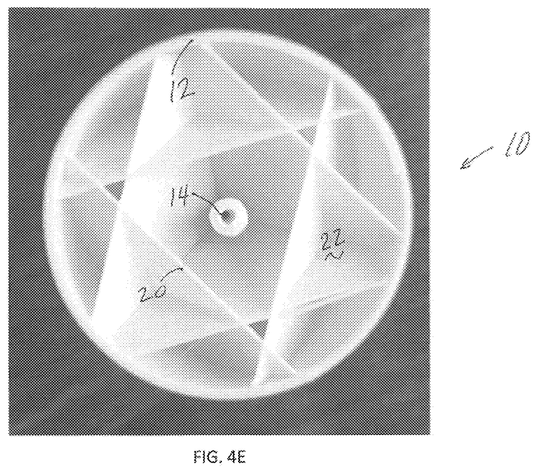

In some embodiments, the shell 12 of the float body is fully hollow. In other embodiments, one or more internal walls, ribs or flanges 20 are provided within the interior of the shell 12, forming a plurality of internal chambers 22 sealed within the interior of the shell. With particular reference to FIGS. 3 and 4, the interior of the shell 12 can be divided by one, two, three or more internal walls, ribs or flanges 20, dividing the interior of the shell into a corresponding plurality of internal chambers 22, in a diametrical, axial, honeycomb or other configuration or arrangement. The internal walls 20 function to strengthen the outer shell 12 against impact damage, and the plurality of separately sealed internal chambers 22 provide redundant buoyancy in the event that one or fewer than all of the chambers is/are compromised by cracking or breakage.

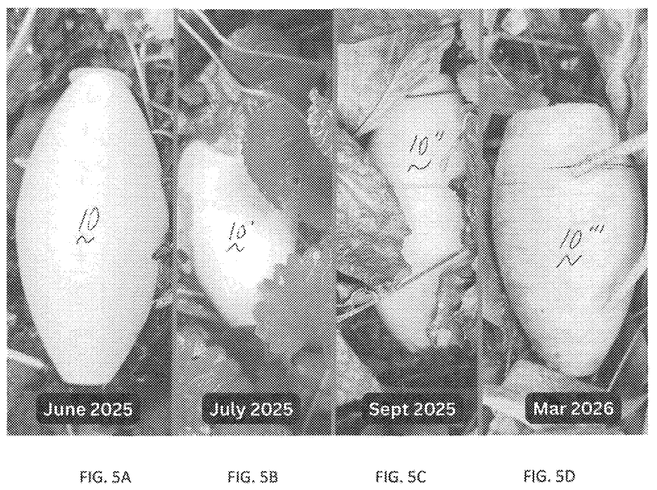

FIGS. 5A-5D show a sequence of biodegradable breakdown of an example of a biodegradable float 10 over the course of several months, with 10, 10′, 10″ and 10′″ showing the float at different stages of biodegradable breakdown. The construction of the shell 12, sleeve 14, internal walls 20, and any other structural elements of the float 10 comprising of a polyhydroxyalkanoate (PHA)-based biodegradable polymer composition allows the float 12 to biodegrade over time into environmentally inert materials, without microplastic residue, if the float is lost during fishing, for example due to the line 30 breaking. The rate of biodegradable breakdown can be selectively tailored or tuned in the design and manufacture process, by appropriate selection of the material(s) of construction, wall thicknesses, and structural design parameters.

### Example 1

Prototype Degradation Testing. A prototype biodegradable fishing bobber was formed from a polyhydroxyalkanoate (PHA)-based polymer composition using fused deposition modeling (FDM) with a cubic lattice infill pattern at approximately 5% infill density and a uniform wall thickness of approximately 1.2 mm. The bobber body had a length of approximately 4 inches and a diameter of approximately 2 inches, corresponding to a length-to-diameter ratio of approximately 2:1. The prototype was subjected to terrestrial environmental exposure conditions. The onset of structural failure was observed at approximately 3 months of exposure. The rate of biodegradation may vary depending on environmental conditions, including moisture level, temperature, microbial activity, and exposure medium. Degradation may occur in terrestrial environments such as soil or land, as well as in aquatic environments including freshwater and marine water, with the specific rate influenced by the environmental conditions present at the site of exposure.

The PHA material used in Example 1 carries TOV Austria's OK biodegradable MARINE certification, which provides third-party validated evidence of biodegradation performance in marine environments consistent with internationally recognized standards. The combination of real-world terrestrial degradation data and TÜV Austria marine biodegradation certification provides a documented basis for the controlled degradation performance of the bobbers described herein.

### Example 2

TABLE 1
A material composition of 77%-79% PHA with the rest being Talc and/or Calcium
carbonate. A colorant may be added to increase visibility of the bobber.

| Component | % by Weight | Function/Performance |
|---|---|---|
| Amorphous PHA | 25-75% | Provides flexibility, reduces brittleness, aids |
| (PHACT A1000P) | | manufacturability. Alone may not provide |
| | | sufficient impact resistance; combined with |
| | | semi-crystalline PHA enables optimal balance |
| Semi-crystalline | 25-75% | Provides stiffness and shape retention. Alone |
| PHA (PHACT S1000P) | | may be too brittle; blend achieves durability and |
| | | manufacturability |
| Total PHA | ~70-90% | Base biodegradable polymer. May help achieve |
| | | balance of mechanical performance and |
| | | biodegradability |
| Talc | 0-30% | Increases stiffness, hardness, and dimensional |
| | | stability during injection molding. Naturally |
| | | occurring filler; allows thin walls (~0.4-1.2 mm) |
| | | without breaking; non-obvious to use for |
| | | floatation due to weight |
| Calcium carbonate | 0-30% | Enhances rigidity, thermal stability, reduces |
| (CaCO₃) | | shrinkage |
| Optional additives | <5% | Supports hollow chambers and tunable density |
| | | without impacting biodegradability. Fine-tunes |
| | | mechanical properties, color, and degradation |

This material and filler selection allows thin walls and enables hollow internal chambers, reduces effective density below water (~1 g/cm³) for floatation and mechanical strength during use. When bobber is lost and chambers are compromised float sinks to the bottom of water body and degrades faster than it would if material density was less than water. Filled PHA is typically used for packaging and molded items-using it for a floating device is counter-intuitive and non-obvious because fillers are typically understood to increase density. By combining internal hollow chambers with filler-tuned PHA composition, the bobber achieves both mechanical durability and floatation, while remaining biodegradable. The added weight due to a higher density material allows for longer casting, whereas other bobbers on the market are typically used in combination with lead sinkers or other added weights to achieve such casting distances.

TABLE 2
Example Physical Dimensions & Proportions:

| Parameter | Example/Range | Functionality |
|---|---|---|
| Length | 4 inches (102 mm)/.25 inch | Standard bobber size; supports |
| | to 14 inch | casting distance |
| Diameter | 2 inches (51 mm)/.25 inches | Optimized for stability in water |
| (widest) | to 14 inches | |
| Wall | 1.2 mm/0.2 to 1 inch | Thinner walls reduce density quicker |
| thickness | | degradation; thicker walls increase |
| | | durability, slows degradation; allows |
| | | tunable degradation time |
| Length-to- | 2:1/2:1-6:1 (ogive-shaped) | Optimizes casting aerodynamics and |
| diameter | | water stability |
| ratio | | |
| Volume | 128 cm³/0.134-2000 cm³ | Tunable for different casting |
| | (large float/buoy) | distances and visibility |
| Weight | 31 g/0.06-1999 g | Achieved without lead; supports eco- |
| | | friendly design |
| Density | 0.16-0.99 g/cm³ | Tunable via chamber volume fraction |
| | | and filler content; ensures floatation |
| | | and casting performance |

TABLE 3
Example Internal Structure & Performance, Multi-Chamber & Rib Design:

| Feature | Function/Cause → Effect | Functionality |
|---|---|---|
| Hollow chambers | Reduces effective density | High filler content would typically |
| | to provide floatation | be considered to reduce |
| | | floatation; hollow design solves |
| | | this problem |
| Internal ribs | Absorb impact, transfer | Allows thin walls without |
| | stress to ribs, prevent | compromising strength; enables |
| | outer shell breakage | controlled degradation |
| Wall thickness | Thicker wall for more | Tunable durability and |
| variation | durability. Thinner wall | degradation rate |
| | for quicker degradation. | |
| Chamber | Multiple chambers ensure | Non-obvious combination of |
| geometry | buoyancy even if one is | geometry + material + fillers |
| | breached | |

The disclosed structural design and material provide mechanical robustness and floatation, which allows a biodegradable design that withstands use. The semi-crystalline/amorphous PHA blend prevents brittle failure on impact. Talc and CaCO₃ fillers allow manufacturing to tune stiffness, hardness, and moldability to allow thin walls and precise chamber shapes. Hollow chambers reduce effective density to below water density, providing floatation, while allowing filler-tuned mechanical strength. Ogive shape and length-to-diameter ratio of some example forms optimize casting distance and water stability.

Factors influencing degradation rate include: PHA blend ratio (semi-crystalline vs amorphous); Copolymer composition and crystallinity; Filler type and concentration (talc/CaCO₃); Wall thickness and surface area; Chamber number and size. This ensures the bobber remains functional for day-to-day use but degrades into environmentally benign components if lost.

Example manufacturing methods may include, without limitation, additive manufacturing (FFF/FDM): prototyping and complex internal structures; and/or injection molding/compression molding/extrusion: high-volume production with controlled wall thickness, filler distribution, and chamber geometry.

The present invention includes a biodegradable fishing bobber comprising a body configured to float in water and support a fishing line, wherein the body is formed from an engineered biodegradable polymer composition, and wherein the body is configured to degrade in an aquatic or soil environment after sustained exposure thereto.

In further example embodiments, the biodegradable polymer composition comprises one or more polymers selected from the group comprising, consisting, or consisting essentially of polyhydroxyalkanoate (PHA), polylactic acid (PLA), polybutylene succinate (PBS), polycaprolactone (PCL), and combinations thereof. In further example embodiments, the biodegradable polymer composition comprises greater than about 50% by weight of biodegradable polymer. In further example embodiments, the float is entirely or substantially entirely constructed of a biodegradable polymer composition comprising one or more polymers selected from the group comprising, consisting, or consisting essentially of polyhydroxyalkanoate (PHA), polylactic acid (PLA), polybutylene succinate (PBS), polycaprolactone (PCL), and combinations thereof. In further example embodiments, the biodegradable polymer composition further comprises at least one additive selected from the group comprising, consisting, or consisting essentially of mineral fillers, pigments, stabilizers, plasticizers, and nucleating agents. In further example embodiments, the additive comprises a filler selected from the group comprising, consisting, or consisting essentially of talc, calcium carbonate, and combinations thereof, in an amount between approximately 5% and 40% by weight.

In further example embodiments, the body of the biodegradable fishing bobber comprises an internal multi-chamber structure configured to maintain buoyancy if a portion of the body is damaged. In further example embodiments, the body comprises two or more internal sealed chambers. In further example embodiments, the internal chamber geometry and wall thickness are configured to provide tunable buoyancy, structural integrity during use, and controlled degradation after environmental exposure. In further example embodiments, the body comprises a unitary structure. In further example embodiments, the body further comprises a line attachment feature configured to secure the bobber to a fishing line.

In further example embodiments, the density and geometry of the body are configured such that the bobber remains partially submerged when supporting bait and terminal tackle. In further example embodiments, the biodegradable polymer composition is configured to provide a controlled rate of degradation, influenced by polymer type, molecular weight, copolymer composition, degree of crystallinity, additives, wall thickness, surface area, or internal chamber configuration. In further example embodiments, the biodegradable polymer composition has a specific gravity greater than 1 such that, upon compromise of the bobber outer shell, the bobber body sinks in water.

The present invention also includes a method of manufacturing a biodegradable fishing bobber comprising providing a biodegradable polymer composition, forming the polymer composition into a bobber body having geometry configured for buoyancy and casting performance, and solidifying the biodegradable polymer composition to form a biodegradable fishing bobber.

In further example embodiments, the polymer composition comprises one or more polymers selected from the group comprising, consisting, or consisting essentially of PHA, PLA, PBS, PCL, and combinations thereof.

In further example embodiments, the forming step of the method of manufacture comprises additive manufacturing, injection molding, compression molding, extrusion, and/or combinations thereof.

In further example embodiments, the method of manufacture also comprises incorporating at least one additive selected from mineral fillers, pigments, stabilizers, plasticizers, and nucleating agents into the biodegradable polymer composition.

While the invention has been described with reference to example embodiments, it will be understood by those skilled in the art that a variety of modifications, additions and deletions are within the scope of the invention, as defined by the following claims.

What is claimed is:

1. A biodegradable float for fishing, the float comprising an outer shell and at least one hollow interior chamber within the outer shell, the float comprising a biodegradable polymer composition selected from polyhydroxyalkanoate, polylactic acid, polybutylene succinate, polycaprolactone, and combinations thereof.

2. The biodegradable float of claim 1, wherein the biodegradable polymer composition comprises a blend of semi-crystalline polyhydroxyalkanoate and amorphous polyhydroxyalkanoate.

3. The biodegradable float of claim 2, wherein the float further comprises at least one filler material selected from talc, calcium carbonate, and combinations thereof.

4. The biodegradable float of claim 1, further comprising at least one additive selected from mineral fillers, pigments, stabilizers, plasticizers, and nucleating agents.

5. The biodegradable float of claim 1, comprising at least 70% polyhydroxyalkanoate.

6. The biodegradable float of claim 4, comprising at least 90% polyhydroxyalkanoate.

7. The biodegradable float of claim 1, further comprising at least one interior wall dividing the hollow interior of the outer shell into a plurality of interior chambers.

8. The biodegradable float of claim 7, comprising at least two interior walls dividing the hollow interior of the outer shell into at least three interior chambers.

9. The biodegradable float of claim 7, wherein the float maintains buoyancy in water in the event of the outer shell being damaged and at least one of the plurality of interior chambers being compromised and filled with water.

10. The biodegradable float of claim 1, further comprising a tubular line sleeve extending through the outer shell to receive and allow a length of fishing line or leader to pass therethrough with a free-running or loose interference fit.

11. The biodegradable float of claim 1, wherein the outer shell comprises a spherical, rounded, oblong, ogive, ovoid outer shape configuration.

12. The biodegradable float of claim 11, wherein the outer shell comprises a generally ogive taper at first and second ends thereof, with a maximum diameter near a center portion thereof and smaller first and second diametrical dimensions at the first and second ends, and having an axial length substantially longer than the maximum diameter.

13. The biodegradable float of claim 12, wherein the axial length is at least 1.25 times the maximum diameter.

14. The biodegradable float of claim 13, wherein the axial length is at least twice the maximum diameter.

15. The biodegradable float of claim 1, wherein the float biodegrades into environmentally inert materials without microplastic residue.

16. The biodegradable float of claim 1, having a bulk density of between approximately 0.16 g/cm³ and approximately 0.99 g/cm³.

17. The biodegradable float of claim 1, wherein the outer shell has a maximum wall thickness of less than approximately 6 mm.

18. A biodegradable float for fishing, the float comprising:
a water-tight outer shell bounding a generally hollow interior, and having a maximum wall thickness of less than approximately 6 mm;
at least one interior wall dividing the generally hollow interior of the outer shell into a plurality of interior chambers, whereby the float maintains buoyancy in water in the event of the outer shell being damaged and at least one of the plurality of interior chambers being compromised and filled with water; and
wherein the outer shell and the at least one interior wall comprise a biodegradable polymer composition comprising at least 70% polyhydroxyalkanoate.

19. The biodegradable float of claim 18, wherein the biodegradable polymer composition comprises a blend of semi-crystalline polyhydroxyalkanoate and amorphous polyhydroxyalkanoate.

20. The biodegradable float of claim 18, wherein the biodegradable polymer composition further comprises at least one additive selected from mineral fillers, pigments, stabilizers, plasticizers, and nucleating agents.

21. The biodegradable float of claim 18, wherein the outer shell comprises a generally ogive taper at first and second ends thereof, with a maximum diameter near a center portion thereof and smaller first and second diametrical dimensions at the first and second ends, and having an axial length of at least two times the maximum diameter.

22. The biodegradable float of claim 18, wherein the float biodegrades into environmentally inert materials without microplastic residue.

23. The biodegradable float of claim 18, having a bulk density of between approximately 0.16 g/cm³ and approximately 0.99 g/cm³.

24. A method of manufacturing a biodegradable float for fishing, the method comprising forming a water-tight outer shell bounding a generally hollow interior, the outer shell being formed of a biodegradable polymer composition selected from polyhydroxyalkanoate, polylactic acid, polybutylene succinate, polycaprolactone, and combinations thereof; wherein the forming step comprises additive manufacturing, 3D printing, injection molding, compression molding, extrusion, and/or combinations thereof.
